(19) United States
(12) Patent Application Publication
(10) Pub. No.: US 2007/0111808 A1
(43) Pub. Date: May 17, 2007

(54) Knuckle with thermal protector

(76) Inventors: Jose Ramon Izquierdo Nunez, Burgos (ES); Esteban Canibano Alvarez, Villablino Leon (ES); Rafael Teijeiro Castro, Valladolid (ES)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 10/563,732

(22) PCT Filed: Jul. 7, 2003
(86) PCT No.: PCT/ES03/00337

§ 371 Date: Nov. 27, 2006

(51) Int. Cl. F16D 1/12

(52) U.S. Cl. 464/160

(57) ABSTRACT

Of application for suspension and steering systems and/or stabilizer bars which are located in the vicinity of a source of excessive heat generation such as a brake, it basically incorporates a thermal protector (9) integrated in the ball joint which presents a series of flexible radial plates (10) on its upper face defining interiorly a circular opening (11) which is attached to a connecting ring (12) previously fixed to the neck (7) of the dust boot (6) by overinjection or pressure and/or gluing, so that the thermal protector (9) covers the dust boot (6) in order to protect it from the high temperatures generated in the surrounding area.

### OBJECT OF THE INVENTION

The present invention refers to a ball joint of the type used in vehicle suspension and steering systems or stabilizers bars fitted with a dust boot to prevent the entry of dirt.

It is the object of the invention that the ball joint should incorporate an integrated thermal protector that will minimize the transmission of heat to the interior of the ball joint, in particular the heat generated by the brakes of the vehicle in order to prevent the rubber dust boot or cover from being damaged by the high temperatures generated in the surrounding area.

It is also an object of the invention that the thermal protector should be perfectly integrated in the ball joint-with the additional assistance of a connecting ring, affixed previously to the dust boot on which the protector is suitably attached.

### BACKGROUND OF THE INVENTION

On vehicle suspension and steering systems it is common to make use of ball joints to interconnect components in such a way that they facilitate the angular variations that take place in the relative movement between these components.

The ball joints comprise a swivel housing fitted with means for coupling to a first component of the suspension for instance, and they are provided with a housing in which there is a bush accommodating the ball head of the knuckle stem, which is in turn extended in an upper section linked to a second component, in relation to which the first component undergoes angular variations.

Suspension ball joints are located in a position very close to the brake disc, so that the heat generated by the braking action is transmitted to the sector where the ball joint is located.

The ball joint normally incorporates a rubber cover or dust boot that is not able to withstand continuous high temperature of more than 85° C. or temperature peaks above 100° C.

Disc brakes, however, may easily reach 500° C. and the heat given off may therefore eventually break down the rubber or dust boot impairing its function, with the result that the cover is unprotected and the failure of the ball joint may take place in a short time.

In order to prevent the dust boot from acquiring high temperatures disc brakes are fitted with heat shields consisting essentially of a large-sized plate that covers the whole of the disc brake.

Another possible solution currently implemented consists of using heat protectors for the ball joint formed of a discrete part fitted independently of the ball joint.

The optimization of the means used for the protection of the ball joint from heat make the invention described below feasible.

### DESCRIPTION OF THE INVENTION

The ball joint with integrated thermal protector proposes a clearly satisfactory solution in comparison with other solutions adopted previously in terms of functional efficacy, installation and reduction of costs.

The use of this ball joint with thermal protector reduces costs considerably in relation to the use of shields on the disc brakes, not only because it is the case of a protection element of smaller size and weight, but also due to the reduction in installation operations and in the number of components.

Furthermore, the thermal protector has an added feature in that it acts as a means of protection against the damage that the ball joint might suffer during handling, as it replaces the plastic cap normally used for this purpose.

Integration of the thermal protector in the ball joint is therefore the basic object of this invention, since it is designed to cover the dust boot normally fitted to the ball joint, which is provided with a connecting ring that is fixed to the dust boot beforehand and on which the thermal protector is attached.

For its part the dust boot consists of a rubber cover which is normally fitted on an upper shoulder of the ball joint swivel housing and is extended upwards with sinuous forms as far as an upper neck which closes around an upper section of the knuckle stem.

The connecting ring may be injected on the neck of the dust boot, being an ideal solution for facilitating the subsequent installation of the protector, as the assembly made up of the dust boot and pre-fitted ring will be received ready formed from the elastomer manufacturer.

In another possible embodiment the ring is press-fitted and/or glued onto the neck of the dust boot.

The thermal protector consists of a body of suitable geometry partly open in one sector of its side face and on its top face it presents a series of flexible radial plates which define a circular opening interiorly.

Upon inserting the protector in the ring from its top face, the plates flex slightly at their inner edges until they pass over some tabs defined on the side face of the ring and they are engaged between the tabs and the base of the ring. In this way the protector is coupled on the ring which had been attached previously to the dust boot.

The protector thus fitted covers the dust boot, preventing it from reaching excessively high temperatures.

### DESCRIPTION OF THE DRAWINGS

To supplement the description being given and to make it easier to appreciate the features of the invention, in accordance with a preferred specimen practical embodiment of same, the present descriptive report is accompanied as an integral part hereof by a set of drawings wherein, for informative but never restrictive purposes, we have represented the following:

FIG. 1. It shows a perspective view of the ball joint with thermal protector.

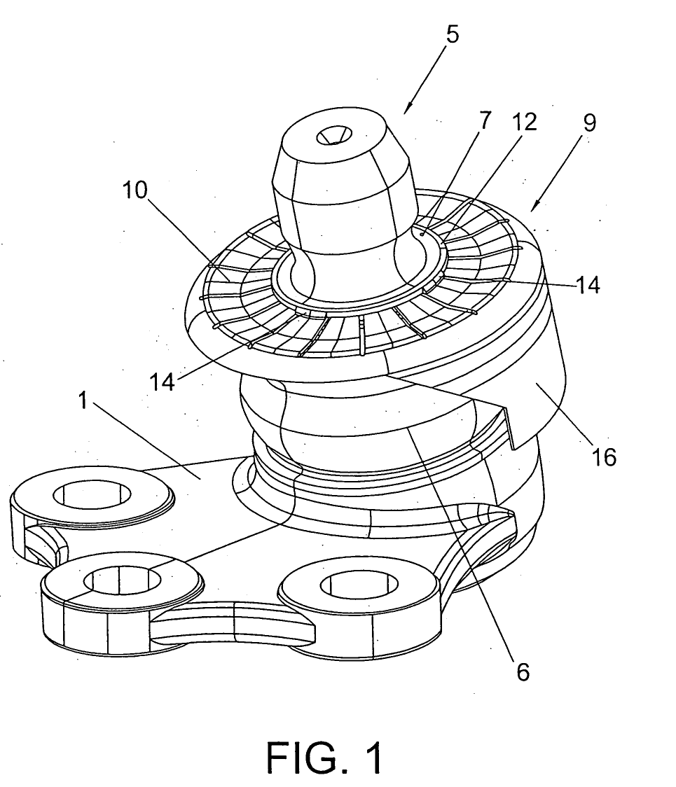

FIG. 2. It shows a sectional side view of the ball joint with thermal protector.

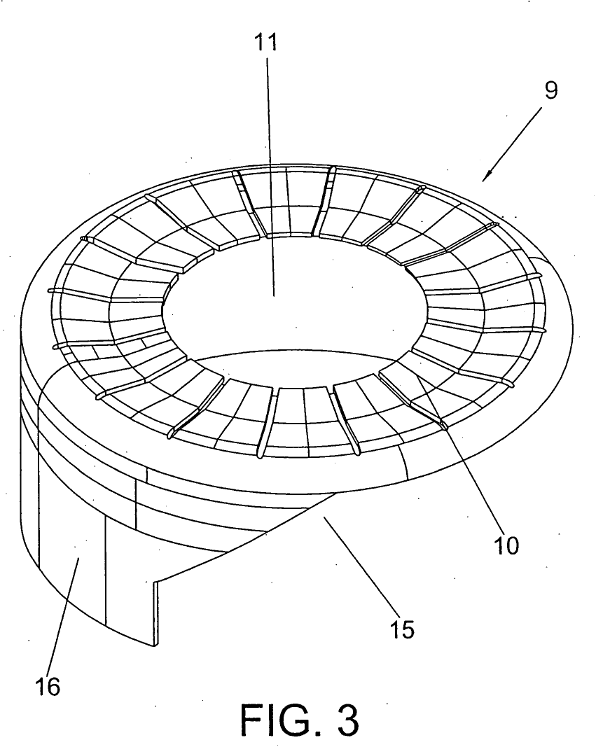

FIG. 3. It shows a perspective view of the thermal protector.

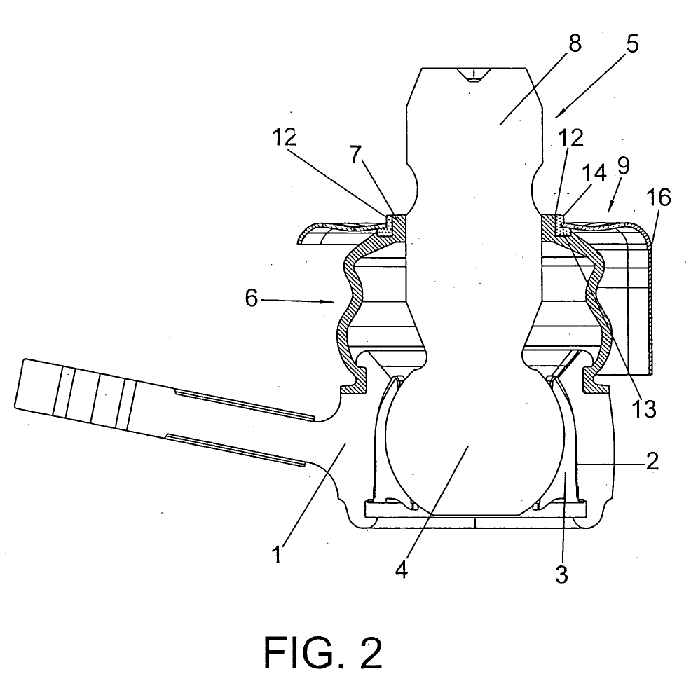

FIG. 4. It shows a perspective view of the connecting ring.

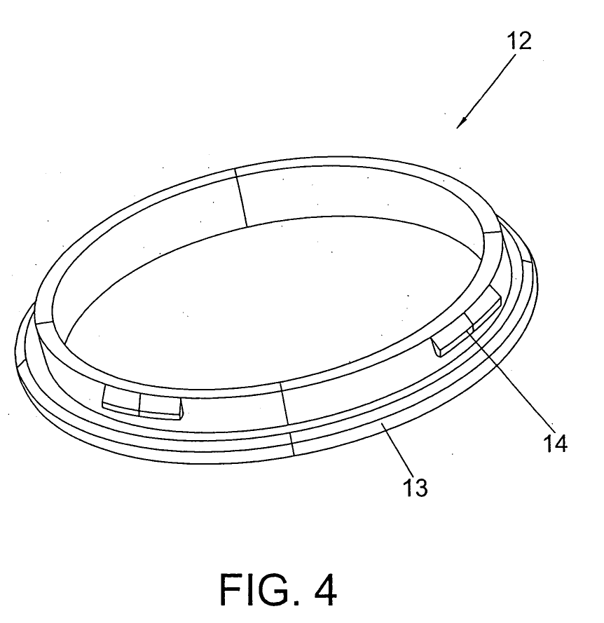

FIG. 5. It shows a perspective view of the protector, ring and dust boot.

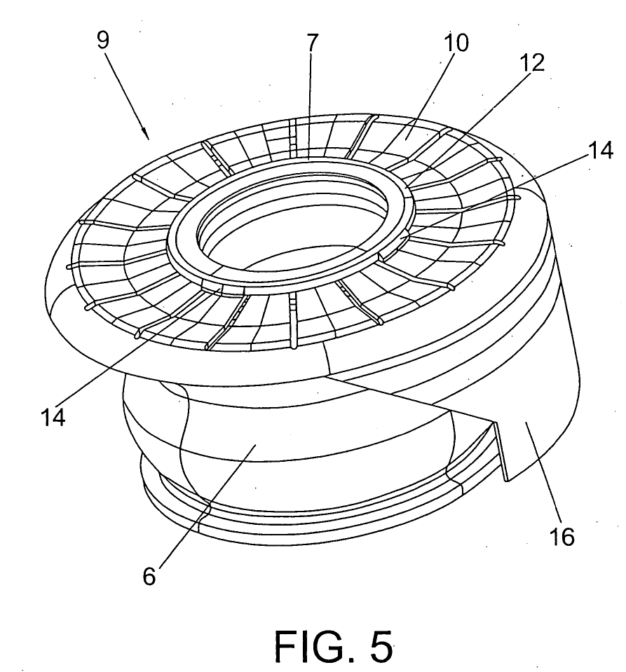

### PREFERRED EMBODIMENT OF THE INVENTION

In the light of the figures we may observe the ball joint with thermal protection that is of application to vehicle suspension and steering systems or stabilizer bars which are located in close proximity to a source of excessive heat generation such as a brake, and which starts from the basic incorporation of a swivel housing (1) on which one of the suspension or equivalent components is coupled and which presents in its interior a housing (2) accommodating a bush (3) which rests and turns in sliding contact on a ball head (4) of a knuckle stem (5), provided with dust boot (6) linked by way of its base to the swivel housing (1) and by its neck (7) to an upper section (8) of the knuckle stem (5).

Starting from this basic configuration the most noteworthy feature of the ball joint is the inclusion of a thermal protector (9) integrated in the ball joint presenting a horizontal upper face that incorporates a series of flexible radial plates (10) which define a circular opening (11) interiorly that is coupled on a connecting ring (12) attached beforehand to the neck (7) of the dust boot (6) by overinjection or pressure and/or gluing, so that the thermal protector (9) covers the dust boot (6) to protect it from the high temperatures generated in the surrounding area.

The connecting ring (12) presents a base (13) and a side face projecting from which there is a series of tabs (14) on which the plates (10) of the upper face of the thermal protector (9) are pressed when the thermal protector (9) is fitted, until the plates (10) pass over said tabs (14) and are engaged between the tabs (14) and the base (13) of the connecting ring (12).

The thermal protector (9) is executed in suitable material to withstand the temperatures and mechanical stress and takes the form of a hood which extends initially in the horizontal upper face and is prolonged inferiorly by way of sloping side edges that terminate in vertical walls (16) defining a spacious cutaway (15) that leaves the dust boot (6) practically exposed in the sector opposite the sector of the ball joint facing the heat source. Said vertical walls (16) are separated from the dust boot (6) defining an air chamber between both which produces the thermal insulation of the dust boot (6).

1-3. (canceled)

4. Ball joint with thermal protection which is of application to suspension and steering systems or stabilizer bars which are located in the vicinity of an source of excessive heat generation such as a brake and which starts from the basic incorporation of a swivel housing (1) on which one of the suspension components or equivalent is attached and which presents in its interior a housing (2) accommodating a bush (3) which rests and turns in sliding contact on a ball head (4) of a knuckle stem (5) provided with a dust boot (6) linked by way of its base to the swivel housing (1) and by its neck (7) to an upper section (8) of the knuckle stem (5), and with a thermal protector (9) integrated in the ball joint protecting the dust boot (6) from high temperatures generated in the surrounding area, characterised in that it incorporates a connecting ring (12) which has a base (13) and a side face from which the project a series of tabs (14), which is previously linked to the neck (7) of the dust boot (6) by superinjection or pressure and/or gluing, and in that the thermal protector (9) presents a horizontal upper face with a series of flexible radial plates (10) that define interiorly a circular opening (11) which is fixed to the connecting ring (12) by pressure of the plates (10) on the tabs (14) until they pass over them, with the result that said plates (10) are engaged between the tabs (14) and the base (13) of the connecting ring (12).

5. Ball joint with thermal protector (9) according to claim 1 characterised in that the thermal protector (9) takes the form of a hood which extends initially in the horizontal upper face and is prolonged inferiorly by way of sloping side edges which terminate in vertical walls (16) defining a spacious cutaway (15) which leaves the dust boot (6) partly exposed in the sector opposite the sector of the ball joint facing the heat source, said vertical walls (16) being separated from the dust boot (6) defining an air chamber between both which produces the thermal insulation of the dust boot (6).
